(19) United States
(12) Patent Application Publication
(10) Pub. No.: US 2019/0305533 A1
(43) Pub. Date: Oct. 3, 2019

(54) CABLE HOLDING DEVICE

(71) Applicant: Phoenix Contact GmbH & Co. KG, Blomberg (DE)

(72) Inventors: Sven Krause, Hiiie (DE); Dat-Minh Trinh, Barntrup (DE); Sebastian Sieg, Kirchbrak (DE); Michael Nolting, Dörentrup (DE)

(73) Assignee: Phoenix Contact GmbH & Co. KG, Blomberg (DE)

(21) Appl. No.: 16/337,235

(22) PCT Filed: Sep. 28, 2017
(86) PCT No.: PCT/EP2017/074708

§ 371 Date: Mar. 27, 2019

(30) Foreign Application Priority Data
Sep. 29, 2016 (LU) LU93242

(51) Int. Cl. H02G 3/06; H02G 15/007

(52) U.S. Cl. CPC H02G 3/0666; H02G 15/007; H02G 3/0675

(57) ABSTRACT

The disclosure relates to a cable holding device for mounting a cable to a housing or a wall opening. The cable holding device may have a first holding element including a first opening and a second holding element including a second opening. The first holding element and the second holding element may be configured to be lockable in a holding position. While in the holding position, the first opening and the second opening may be aligned with one other. The first holding element and the second holding element may be transferable into the holding position by a translational movement.

### CROSS-REFERENCE TO RELATED APPLICATIONS

This application is a 371 national phase filing of International Application No. PCT/EP2017/074708, entitled “CABLE HOLDING DEVICE”, filed 28 Sep. 2017, which claims priority to Luxembourg Patent Application No. 93242, entitled “CABLE HOLDING DEVICE”, filed 29 Sep. 2016.

### BACKGROUND

This disclosure relates to a cable holding device for mounting a cable to a housing or to a wall opening.

In the prior art, such cable holding devices or cable bushings are used to secure cables to the housing of electrical devices while at the same time providing strain relief. To secure a cable, such cable holding devices are typically screw-connected.

A cable bushing of a housing of an electric or electro-optical device is known from the publication DE 10 2008 049 258 B4. The cable bushing includes a hole that is arranged in the housing and through which a cable is guided, wherein the hole is surrounded by a circumferential bearing surface on the housing that is in turn surrounded by a lamellar ring, wherein an intermediate space, which is delimited on the outside by a wall, extends around the lamellar ring, wherein a press-in sleeve is inserted into the intermediate space and is pressed against the wall by a lateral surface. The press-in sleeve has an inner wall section, the inner diameter of which tapers and by means of which, as a result of the insertion in axial direction into the intermediate space, the lamellae of the lamellar ring are bent inward in radial direction. An elastomeric grommet is fitted onto the cable, which rests against the bearing surface, is surrounded by the lamellar ring, is compressed in radial direction by the radially inwardly bent lamellae and secures the cable.

To secure a cable, the press lamellae may be pressed together by means of a cap nut, which may be screwed on and tightened with a defined torque. This is associated with a relatively high assembly complexity.

### SUMMARY

The present disclosure provides an improved cable holding device for securing a cable to a housing of an electrical device.

Different examples of an improved design of a cable holding device are the subject matter of the figures, the description and the claims.

In some examples, an improved cable holding system is achieved by a cable holding device for mounting a cable to a housing or a wall opening having a first holding element including a first opening and a second holding element including a second opening. The first holding element and the second holding element are configured to be lockable in a holding position and, in the holding position, the first opening and the second opening are arranged in alignment with one other, wherein the first holding element and the second holding element are transferable into the holding position by a translational movement. Accordingly, the mounting of a cable on a housing can be realized very easily and without increased assembly complexity. The use of additional tools is not necessary, because there is neither a cap nut nor does a specific torque have to be achieved. The holding position can be attained with simple translational pressure, for example with finger pressure. The first holding element and the second holding element are secured to one another for the subsequent assembly steps. Thus, the first holding element and the second holding element can be handled together as one piece.

In order to lock the first holding element and the second holding element in the holding position in a particularly simple and reliable manner, the cable holding device has latching means to secure the first holding element and the second holding element in the holding position.

According to one example, the latching means has a flexible latching arm. Accordingly, the first holding element and the second holding element can be locked in place very easily. The latching arms can additionally include pawls that can engage with corresponding projections. In this case, the latching connection could no longer be released in a non-destructive manner by simply pulling it apart.

To further simplify the assembly of the cable holding device and to simplify the process for producing the cable holding device, the first holding element and the second holding element together are formed as a one-piece integral component. This reduces the number of components to be mounted and incorrect mounting can thus be prevented.

In another example, the first holding element and the second holding element are respectively formed as a one-piece integral component.

According to another example, the second holding element includes holding lamellae arranged adjacent to the second opening. The holding lamellae are thereby arranged around the second opening in a circumferential direction. The holding lamellae thus make it possible to secure a cable arranged inside the second opening. The securing can thus be achieved by the deformation of the holding lamellae, whereby the arrangement of the holding lamellae in a circumferential direction around the second opening brings about a homogeneous introduction of force.

In order to provide strain relief that is particularly sustained and gentle on the cable, the cable holding device includes a sealing means.

In one example, the sealing means is arranged on an inner side of the holding lamellae. Accordingly, the sealing means can be arranged on the holding lamellae in a particularly precise manner. This saves another assembly step, and errors relating to the arrangement of the sealing means can be prevented.

In order to transfer the cable holding device into a final assembly position in a particularly simple manner and without increased assembly complexity, the first holding element and the second holding element are transferable from the holding position into a final assembly position by a further translational movement. Accordingly, no additional assembly tools or complex measures are necessary to attain the final assembly state. The final assembly position can easily be translationally attained by means of an additional pushing movement, for example finger pressure.

To further simplify the transfer into the final assembly position, the latching means of the cable holding device is configured to secure the first holding element and the second holding element in the final assembly position. This can be accomplished with additional projections, for example, that correspond to the flexible latching arms and the arranged pawls. One simple latching means can thus be used for both the locking in the holding position and the securing in the final assembly position.

In another example, the first holding element may be used to radially deform the holding lamellae of the second holding element in the final assembly position, in order to reduce a cross section of the second opening. Accordingly, the holding lamellae are pressed onto the sealing means, thus relieving the tension on a cable arranged inside the second opening.

In order to protect the cable holding device in the final assembly position, the cable holding device includes a cover element, which may be placed onto the cable holding device in the final assembly position.

In another example, the cover element has a holding means, which may relieve tension on a cable arranged inside the cable holding device. Accordingly, the strain relief for a cable is additionally improved. This can in particular be achieved with a fork-shaped holding means.

To further reduce the assembly complexity and prevent the loss of individual components of the cable holding device, the cover element has a cord that connects the cover element to the first holding element or the second holding element to ensure that said elements do not get lost. The cover element and the first holding element or the second holding element can thereby be formed in one piece as an integral component.

In some examples, an improved cable holding system is achieved by a cable holding system having a cable holding device and a housing. Here too, the mounting of a cable on the housing is very simple and can be accomplished without increased assembly complexity. Neither additional tools nor an additional cap nut are necessary.

According to another example, the second holding element and the housing are formed in one piece as an integral component. Accordingly, the whole cable holding system can be provided with fewer individual parts and reduced production costs.

### BRIEF DESCRIPTION OF THE DRAWINGS

Further examples are illustrated in the drawings and are described in more detail in the following.

FIG. 1A shows a schematic illustration of a cable holding device from the prior art,

FIG. 1B shows a schematic illustration of a cable holding device from the prior art in longitudinal section,

FIG. 1C shows a further schematic illustration of a cable holding device from the prior art in longitudinal section,

FIG. 2A shows a perspective view of a first holding element,

FIG. 2B shows a further perspective view of a first holding element,

FIG. 2C shows another illustration of a first holding element,

FIG. 3A shows an illustration of a second holding element,

FIG. 3B shows a further illustration of a second holding element,

FIG. 4A shows an illustration of a cable holding device with a cable,

FIG. 4B shows a schematic illustration of a cable holding device,

FIG. 4C shows a further schematic illustration of a cable holding device,

FIG. 5 shows another illustration of a cable holding device,

FIG. 6A shows another perspective view of a cable holding device,

FIG. 6B shows a schematic illustration of a cover element,

FIG. 6C shows a further schematic illustration of a cable holding device in longitudinal section,

FIG. 6D shows another schematic illustration of a cable holding device in longitudinal section,

FIG. 7A shows a further schematic illustration of a cable holding device with a cover element, and

FIG. 7B shows another schematic illustration of a cable holding device with a cover element.

### DETAILED DESCRIPTION

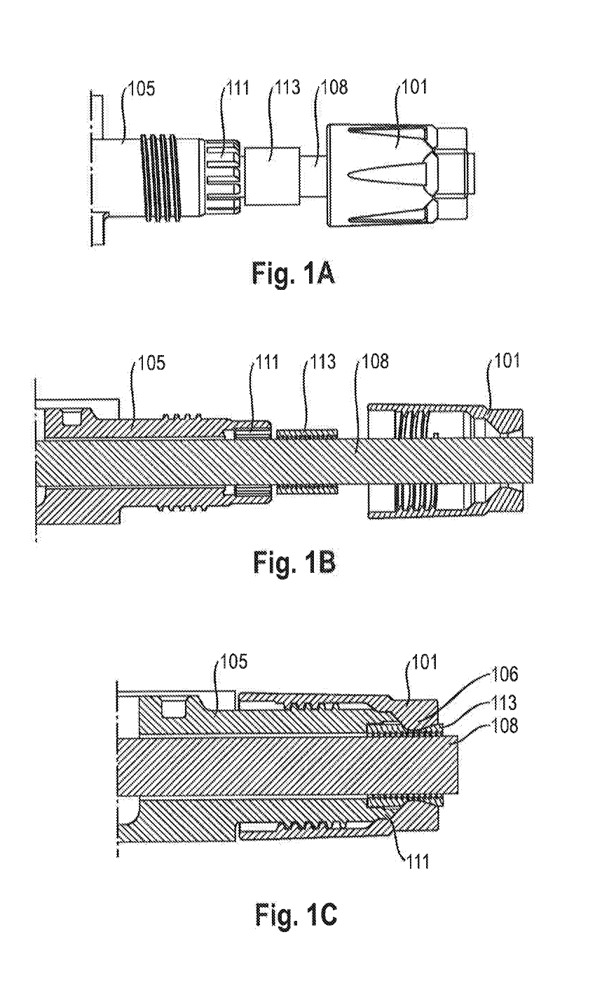

FIG. 1A shows a schematic illustration of a cable holding device from the prior art. The cable holding device for mounting a cable 108 includes a first holding element 101 and a second holding element 105. The first holding element 101 and the second holding element 105 can be transferred into a final assembly state by screwing the two holding elements together. The second holding element 105 includes a plurality of holding lamellae 111 which are deformed when the first holding element 101 is screwed on. The deformed holding lamellae 111 act radially on a sealing means 113, and thus relieve the tension on the cable 108. In the prior art, such cable holding devices or cable bushings are typically used to secure cables 108 to the housing of electrical devices, while at the same time providing strain relief.

FIG. 1B shows a schematic illustration of a cable holding device from the prior art in longitudinal section. The cable 108 extends within the first holding element 101, through the sealing means 113 and into the second holding element 105. The holding lamellae 111 are arranged at a distance from the inner cable, as a result of which the sealing means 113 can be inserted into an intermediate space by axial displacement under the holding lamellae 111.

FIG. 1C shows a further schematic illustration of a cable holding device from the prior art in longitudinal section. The first holding element 101 is in a state in which it is screwed onto the second holding element 105, as a result of which the cable 108 is secured and strain relief is provided. As a result of the action of a projection 106 on the holding lamellae 111, a force is applied to the cable 108 via the sealing means 113.

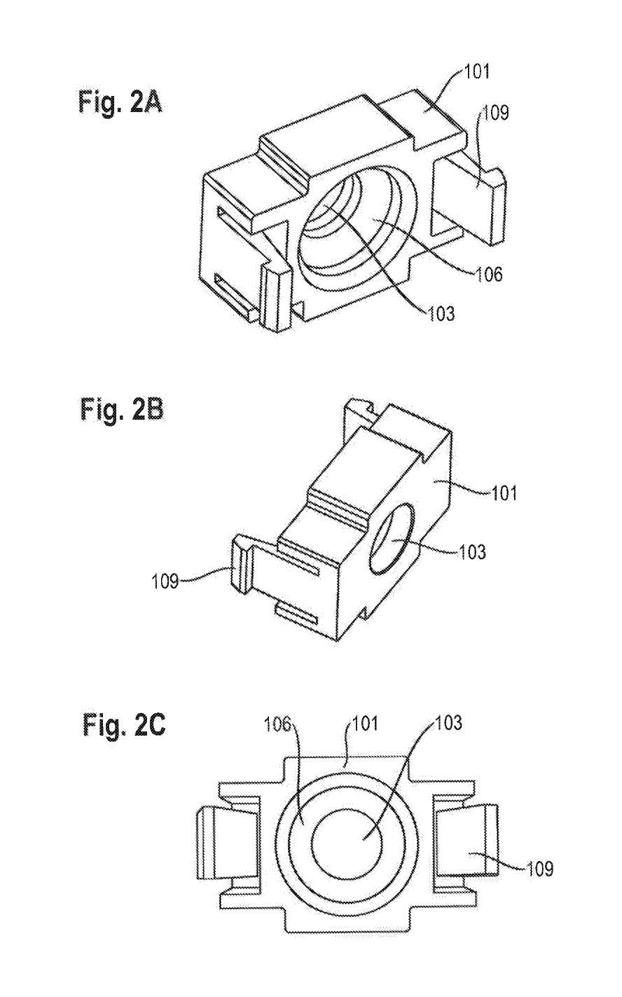

FIG. 2A shows a perspective view of a first holding element 101. The first holding element 101 has a cuboidal base body and may be locked in a holding position with a second holding element 105 (not shown) by means of a translational movement. The first holding element 101 has latching means 108 in the form of two latching arms, each of which includes a pawl on an end of each latching arm facing away from the base body. The latching arms make it possible to secure the first holding element 101 and the second holding element 105 in the holding position. The latching connection can consequently no longer be released in a non-destructive manner by simply pulling it apart. The first holding element 101 additionally includes a first opening 103, through which a cable 108 (not shown) can be guided. A longitudinal axis of a cable 108 guided through the first opening 103 and the translational direction of the movement for locking the first holding element 101 to the second holding element 105 are thus identical. A projection 106, which can interact with holding lamellae 111 (not shown) of the second holding element 105, is formed by a conical section inside the first opening 103.

FIG. 2B shows a further perspective view of the first holding element 101 having the first opening 103 and latching means 109 arranged laterally on the base body of the first holding element 101.

FIG. 2C shows another illustration of a first holding element 101 in a plan view.

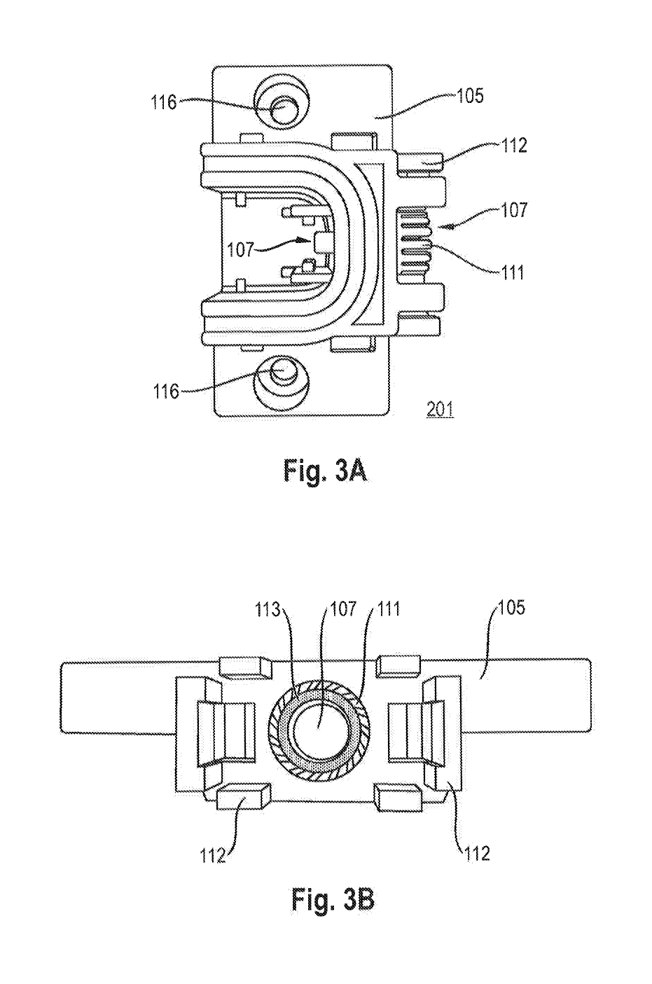

FIG. 3A shows an illustration of a second holding element 105. The second holding element 105 includes holding lamellae 111, which are arranged adjacent to a second opening 107. The holding lamellae 111 are arranged around the second opening 107 in a circumferential direction. A plurality of alignment means 112 are positioned directly adjacent to the holding lamellae 111, which makes a precise positioning of the first holding element 101 on the second holding element 105 possible. In order to fasten the second holding element 105 to a housing wall, for example, the second holding element 105 additionally has holes 116.

FIG. 3B shows a further illustration of the second holding element 105 in a plan view. The second holding element 105 has the alignment means 112, the holding lamellae 111 and the second opening 107. The second holding element 105 additionally includes a sealing means 113, which is arranged on an inner side of the holding lamellae 111. The sealing means 113 is configured as a cylindrical body and is inserted into the holding lamellae 111 on the front end.

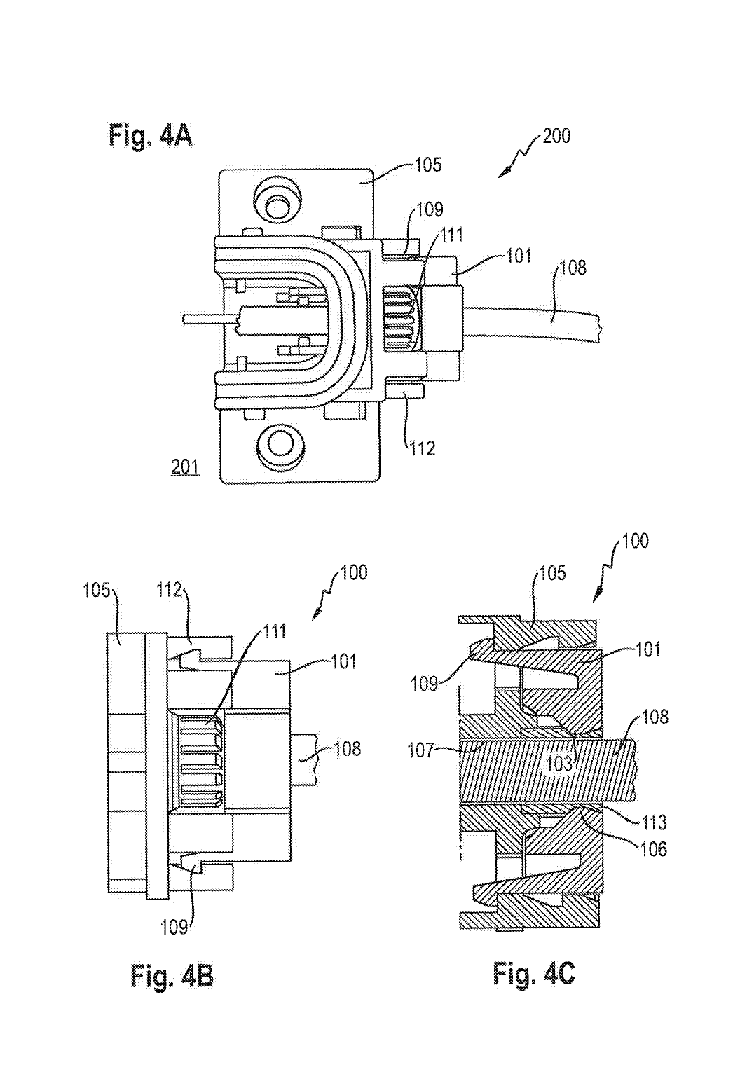

FIG. 4A shows an illustration of a cable holding device 100 with an inserted cable 108. The cable holding device 100 for mounting a cable 108 to a housing 201 includes the first holding element 101 having the first opening 103 and the second holding element 105 having the second opening 107. The first holding element 101 and the second holding element 105 have already been transferred into the holding position. The first opening 103 and the second opening 107 are configured to be in alignment with one another and a cable 108 is guided through both openings. By means of the alignment means 112 on the second holding element 105 in conjunction with the latching means 109 of the first holding element 101, the first holding element 101 and the second holding element 105 were transferred into the holding position with a translational movement.

FIG. 4B shows a schematic illustration of a cable holding device 100. The cable holding device 100 of FIG. 4A and the cable holding device 100 of FIG. 4B are arranged in the identical holding position. In this holding position, the entire cable holding device 100 can be handled as a one-piece component for the further assembly steps, whereby a displacement of the cable 108 is possible. This is due to the fact that the holding lamellae 111 of the second holding element 105 are not yet deformed in the holding position. Therefore, no force is being exerted on the sealing means 113 and the cable 108, as a result of which the cable 108 is displaceable.

FIG. 4C shows a further schematic illustration of a cable holding device 100. The cable holding device 100 is in a final assembly position, in which the cable 108 on the inside is secured and strain relief is realized. The first holding element 101 and the second holding element 105 have been transferred from the holding position into a final assembly position with a further translational movement. In some cases, the further translational movement to achieve the final assembly position is in the same direction in which the translational movement for locking the first holding element 101 and the second holding element 105 in the holding position has already occurred. The latching means 109 of the first holding element 101 may secure the first holding element 101 and the second holding element 105 in the final assembly position as well. In the final assembly position, the pawls arranged on the latching arms engage with deeper-lying additional projections which correspond to the pawls. Both the locking in the holding position and the securing in the final assembly position can thus be realized with one latching means 109. A projection 106 of the first holding element 101 is configured to act on the holding lamellae 111 of the second holding element 103 in the final assembly position to radially deform said lamellae. This deformation reduces the cross section of the second opening 107 and strain relief is realized via the sealing means 113.

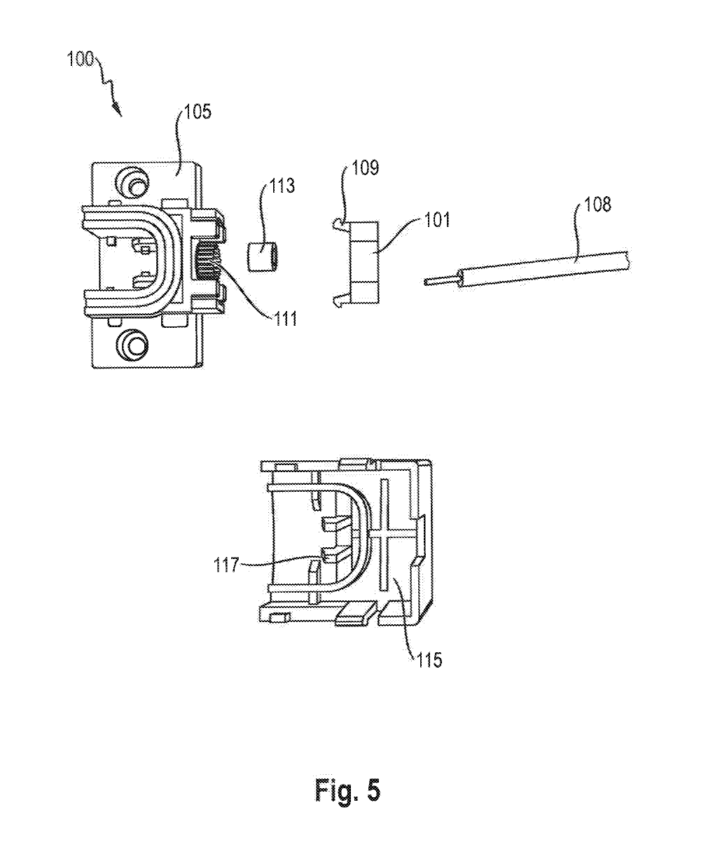

FIG. 5 shows another illustration of the cable holding device 100. The cable holding device 100 additionally includes a cover element 115. The cover element 115 serves as a protective housing, which can be placed onto the cable holding device 100 in the final assembly position. On an inner side, the cover element 115 has a fork-shaped holding means 117. The fork-shaped holding means 117 is clamped laterally onto a section of the cable 108 when the cover element 115 is placed onto the cable holding device 100. Additional strain relief is realized as a result of the clamping.

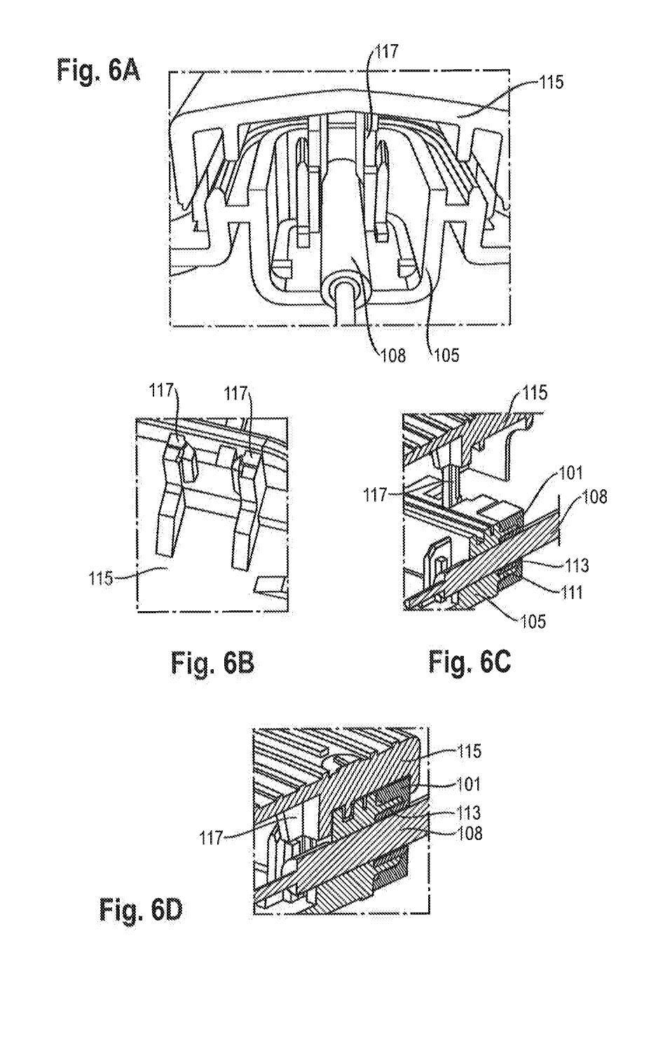

FIG. 6A shows another perspective view of a cable holding device 100. The cover element 115 is placed onto the cable holding device 100 and the fork-shaped holding means 117 is clamped onto the cable 108, as a result of which the holding means 117 produces additional strain relief.

FIG. 6B shows a schematic illustration of a cover element 115 including the fork-shaped holding means 117.

FIG. 6C shows a further schematic illustration of a cable holding device 100 in longitudinal section. The cable holding device 100 is in the final assembly position and a cable 108 is secured in the cable holding device 100. The cover element 115 with the fork-shaped holding means 117 has not yet been placed onto the cable holding device 100.

FIG. 6D shows another schematic illustration of a cable holding device 100 in longitudinal section. The cable holding device 100 is in the final assembly position, a cable 108 is secured in the cable holding device 100 and the cover element 115 with the fork-shaped holding means 117 has been placed onto the cable holding device 100. This state describes a completed assembly state of the cable holding device 100.

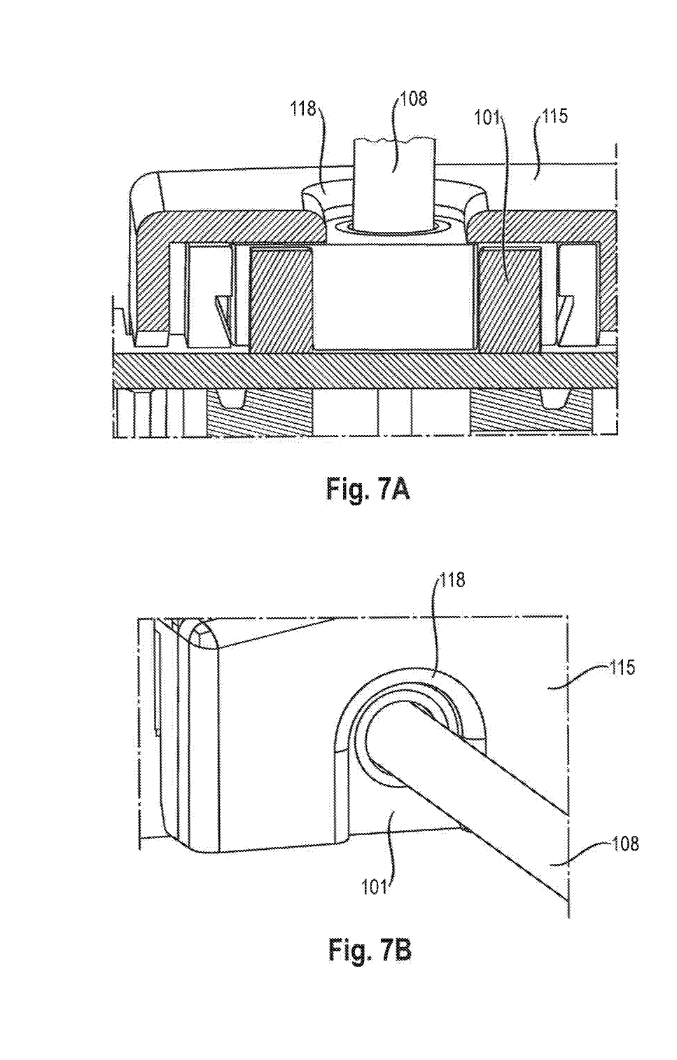

FIG. 7A shows a further schematic illustration of a cable holding device 100 with a cover element 115. The cover element 115 also encloses the first holding element 101, whereby a recess 118 is provided for the cable 108.

FIG. 7B shows another schematic illustration of a cable holding device 100 with a cover element 115 including the recess 118.

All the features explained and shown in connection with the individual examples discussed in this disclosure can be provided in different combinations so as to implement the benefits thereof at the same time.

### List of Reference Numbers

100 Cable holding device
101 First holding element
103 First opening
105 Second holding element
106 Projection
107 Second opening
108 Cable
109 Latching means
111 Holding lamellae
112 Alignment means
113 Sealing means
115 Cover element
116 Hole
117 Holding means
118 Recess
200 Cable holding system
201 Housing

What is claimed is:

1. A cable holding device for mounting a cable to a housing or to a wall opening, comprising:
a first holding element including a first opening; and
a second holding element including a second opening, wherein the first holding element and the second holding element are configured to be lockable in a holding position wherein the first opening and the second opening are arranged in alignment with one another when the first holding element and the second holding element are in the holding position, and wherein the first holding element and the second holding element are configured to be transferable into the holding position by a translational movement.

2. The cable holding device of claim 1, further comprising:
at least one latch configured to secure the first holding element and the second holding element in the holding position.

3. The cable holding device of claim 2, wherein the at least one latch has a flexible latching arm.

4. The cable holding device of claim 1, wherein the first holding element and the second holding element are respectively formed as a one-piece integral component.

5. The cable holding device of claim 2, wherein the second holding element includes holding lamellae that are arranged adjacent to the second opening.

6. The cable holding device claim 5, wherein the holding lamellae are arranged around the second opening in a circumferential direction.

7. The cable holding device of claim 5, further comprising:
a seal.

8. The cable holding device of claim 7, wherein the seal is arranged on an inner side of the holding lamellae.

9. The cable holding device of claim 5, wherein the first holding element and the second holding element are configured to be transferable from the holding position into a final assembly position by a further translational movement.

10. The cable holding device of claim 9, wherein the at least one latch of the cable holding device is configured to secure the first holding element and the second holding element in the final assembly position.

11. The cable holding device of claim 9, wherein the first holding element is configured to radially deform the holding lamellae of the second holding element in the final assembly position, and wherein a cross section of the second opening is reduced based at least in part on radially deforming the holding lamellae.

12. The cable holding device of claim 9, further comprising:
a cover element configured to be placed onto the cable holding device in the final assembly position.

13. The cable holding device of claim 12, wherein the cover element has a support configured to relieve tension on the cable, and wherein the cable is arranged inside the cable holding device.

14. A cable holding system, comprising:
a cable holding device that comprises:
a first holding element including a first opening; and
a second holding element including a second opening, wherein the first holding element and the second holding element are configured to be lockable in a holding position, wherein the first opening and the second opening are arranged in alignment with one another when the first holding element and the second holding element are in the holding position, and wherein the first holding element and the second holding element are configured to be transferable into the holding position by a translational movement; and
a housing.

15. The cable holding system of claim 14, wherein the second holding element and the housing are formed in one piece as an integral component.

16. The cable holding system of claim 14, further comprising:
at least one latch configured to secure the first holding element and the second holding element in the holding position.

17. The cable holding system of claim 14, wherein the second holding element includes holding lamellae, the cable holding system further comprising:
a seal arranged on an inner side of the holding lamellae.

18. The cable holding system of claim 14, further comprising:
a cover element configured to be placed onto the cable holding device in a final assembly position.

19. A method, comprising:
transferring a first holding element having a first opening and a second holding element having a second opening into a holding position, wherein the first holding element and the second holding element are locked in the holding position based at least in part on the transferring, wherein the first opening and the second opening are aligned with one another based at least in part on the transferring, and wherein the first holding element and the second holding element are transferred into the holding position by a translational movement; and
guiding a cable through the first opening and the second opening.

20. The method of claim 19, comprising:
transferring the first holding element and the second holding element into a final assembly position by a further translational movement; and
securing the first holding element and the second holding element in the final assembly position, wherein a holding lamellae of the second holding element is deformed based at least in part on the securing, and wherein a cross section of the second opening is reduced based at least in part on the deformation of the holding lamellae.
